(19) United States
(12) Patent Application Publication
(10) Pub. No.: US 2019/0231040 A1
(43) Pub. Date: Aug. 1, 2019

(54) AIR FILTER UMBRELLA

(71) Applicant: Sheng-Chun LI, Taoyuan city (TW)

(72) Inventor: Sheng-Chun LI, Taoyuan city (TW)

(21) Appl. No.: 16/232,772

(22) Filed: Dec. 26, 2018

(30) Foreign Application Priority Data
Jan. 30, 2018 (TW) 107103275

(51) Int. Cl. A45B 23/00; B01D 46/00

(52) U.S. Cl. CPC A45B 23/00; A45B 2025/003; B01D 46/0038; B01D 46/0005

(57) ABSTRACT

An air filter umbrella includes an umbrella body, an air delivery unit formed in the shaft of the umbrella body, and an air filter assembly fastened to the bottom end of the shaft of the umbrella body and adapted for drawing outside air into the air delivery unit and filtering the intake flow of air for enabling the filtered air to be breathed by the umbrella user.

### BACKGROUND OF THE INVENTION

### 1. Field of the Invention

The present invention relates to umbrella technology and more particularly, to an air filter umbrella, which enables the umbrella user to breathe in clean air, preventing the umbrella user from breathing in polluted air so that the umbrella user can perform outdoor activities safely for a long time.

### 2. Description of the Related Art

As air pollution is becoming more serious, the impact of aerosols on health is greater than any other pollutants. In particular, PM2.5 in air has a more serious impact on the human body. In order to prevent air pollution from harming the body, more and more people wear masks when they go out. However, when wearing a mask, there will be a feeling of unsmooth breathing. When the user wears the glasses, the heat exhaled by the human body will rise along the mask, causing the lenses to fog, and the problem of unclear sight is generated.

### SUMMARY OF THE INVENTION

The present invention has been accomplished under the circumstances in view. It is therefore the main object of the present invention to provide an air filter umbrella, which enables the umbrella user to breathe in clean air, preventing the umbrella user from breathing in polluted air so that the umbrella user can perform outdoor activities safely for a long time.

To achieve this and other objects of the present invention, an air filter umbrella comprises an umbrella body, an air delivery unit and an air filter assembly. The umbrella body comprises a shaft having opposed top end and bottom end, a rib and stretcher assembly radially and pivotally connected to the top end of the shaft, and a canopy covered on the rib and stretcher assembly such that an air dispersing space is defined within the canopy around the shaft. The air delivery unit comprises an air inlet located on the bottom end of the shaft, an air outlet formed on the shaft near the top end of the shaft, and an air delivery channel axially defined in the shaft between the air inlet and the air outlet. The air filter assembly is fastened to the bottom end of the shaft of the umbrella body, comprising an air drive unit adapted for drawing outside air through the air inlet, the air delivery channel and the air outlet into the air dispersion space, and an air filter member for filtering the air being drawn into the air inlet by the air drive unit.

Other advantages and features of the present invention will be fully understood by reference to the following specification in conjunction with the accompanying drawings.

### BRIEF DESCRIPTION OF THE DRAWINGS

FIG. 1 is an exploded view of an air filter umbrella in accordance with the present invention.

FIG. 2 is a sectional side view of the air filter assembly of the air filter umbrella in accordance with the present invention.

FIG. 3 is an exploded view of the air filter umbrella equipped with an aroma unit.

FIG. 4 is a schematic applied view of the air filter umbrella in accordance with the present invention.

### DETAILED DESCRIPTION OF THE PREFERRED EMBODIMENT

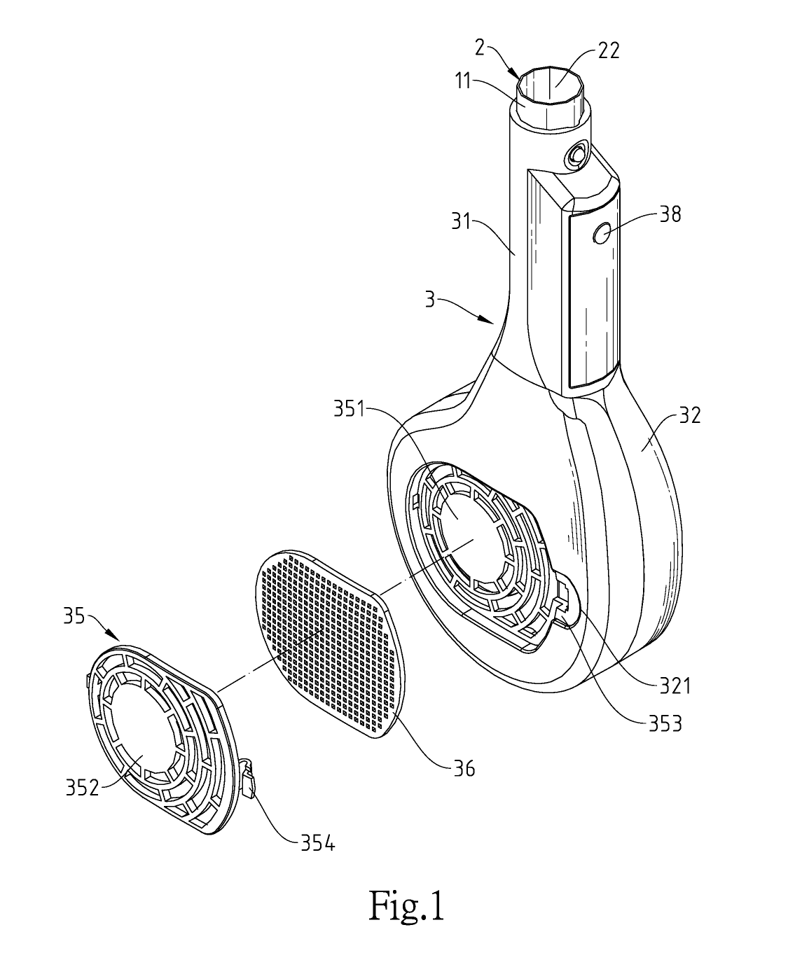

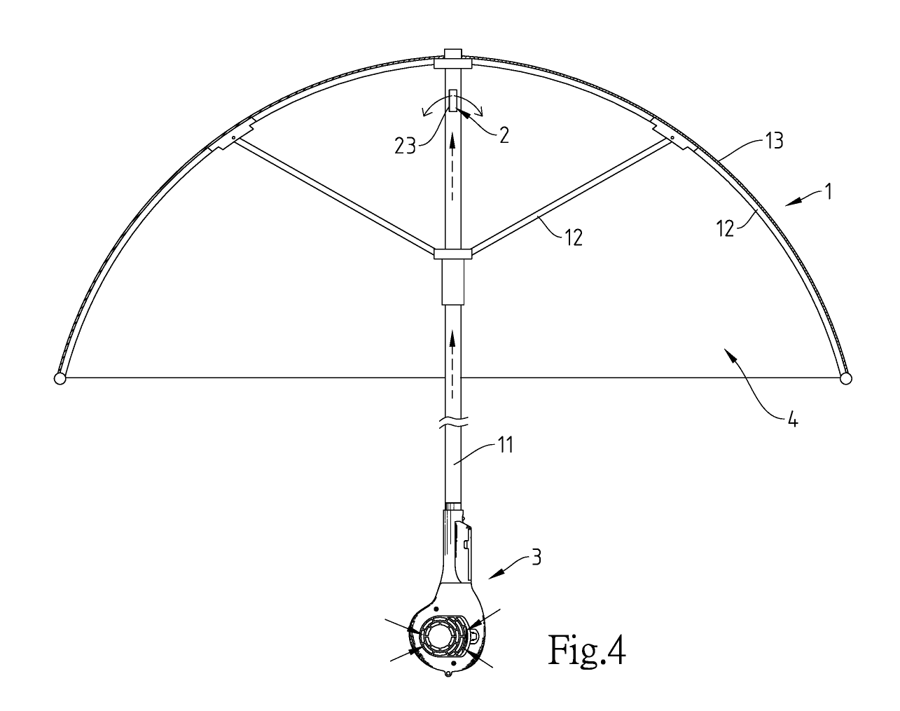

Referring to FIGS. 1, 2 and 4, an air filter umbrella in accordance with the present invention is shown. The air filter umbrella comprises an umbrella body 1, an air delivery unit 2 and an air filter assembly 3.

The umbrella body 1 comprises a shaft 11, a rib and stretcher assembly 12 and a canopy 13. The rib and stretcher assembly 12 is radially and pivotally connected to a top end of the shaft 11. The canopy 13 is covered on the rib and stretcher assembly 12 such that an air dispersing space 4 is defined within the canopy 13 around the shaft 11.

The air delivery unit 2 comprises an air inlet 21 located on an opposing bottom end of the shaft 11, an air outlet 23 that is composed of notches formed on the shaft 11 near the top end thereof, and an air delivery channel 22 axially defined in the shaft 11 between the air inlet 21 and the air outlet 23.

The air filter assembly 3 comprises an adapting grip 31, an air filter unit 32 defining therein a diversion chamber 33, an air drive unit 34 mounted in the diversion chamber 33 and adapted for drawing outside air into the diversion chamber 33, an air grille unit 35 mounted in one side of the air filter unit 32 to face toward the air drive unit 34, and an air filter member 36 mounted in the air grille unit 35. The air grille unit 35 comprises a first air grille 351 and a second air grille 352. The first air grille 351 is disposed between the second air grille 352 and the air drive unit 34 to stop external objects from entering the diversion chamber 33 to damage the air drive unit 34. The air filter member 36 is a wire mesh filter mounted between the first air grille 351 and the second air grille 352.

The adapting grip 31 of the air filter assembly 3 is fastened to the bottom end of the shaft 11 of the umbrella body 1 to keep the air inlet 21 in air communication with the diversion chamber 33.

Further, the first air grille 351 of the air grille unit 35 comprises a ring lug 353 extended from the periphery thereof. The second air grille 352 of the air grille unit 35 comprises a snap 354 fastenable to the ring lug 353. The air filter unit 32 comprises a locating notch 321 located on the outer wall thereof for accommodating the ring lug 353. After the first air grille 351 and the second air grille 352 are placed in the air filter unit 32, the ring lug 353 is received in the locating notch 321, and the snap 354 is inserted through the ring lug 353 and fastened to the locating notch 321.

The air drive unit 34 is a fan motor electrically connected to a power source 37 that is mounted in the air filter unit 32. An on/off switch 38 is mounted on the outer wall of the adapting grip 31 and electrically coupled to the power source 37 and switchable to control electric conduction between the power source 37 and the air drive unit 34.

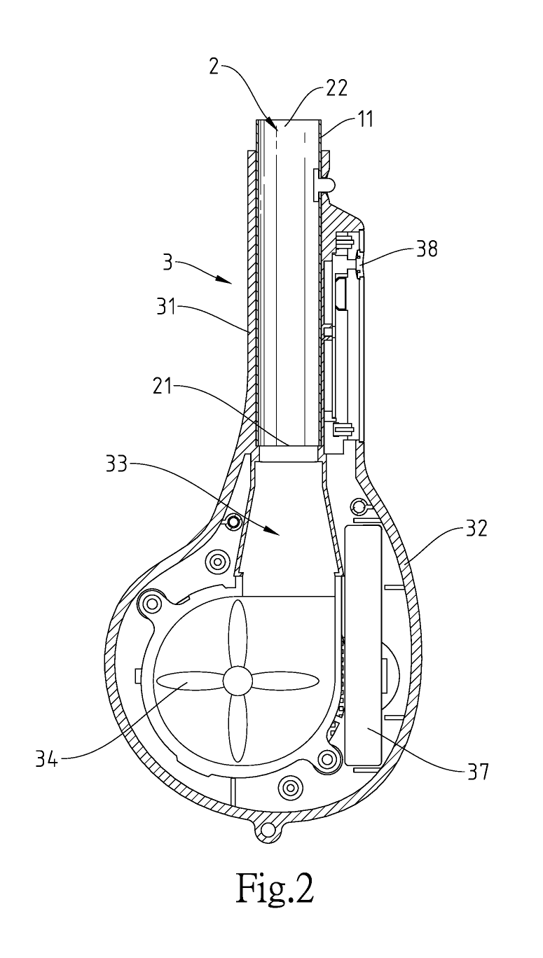

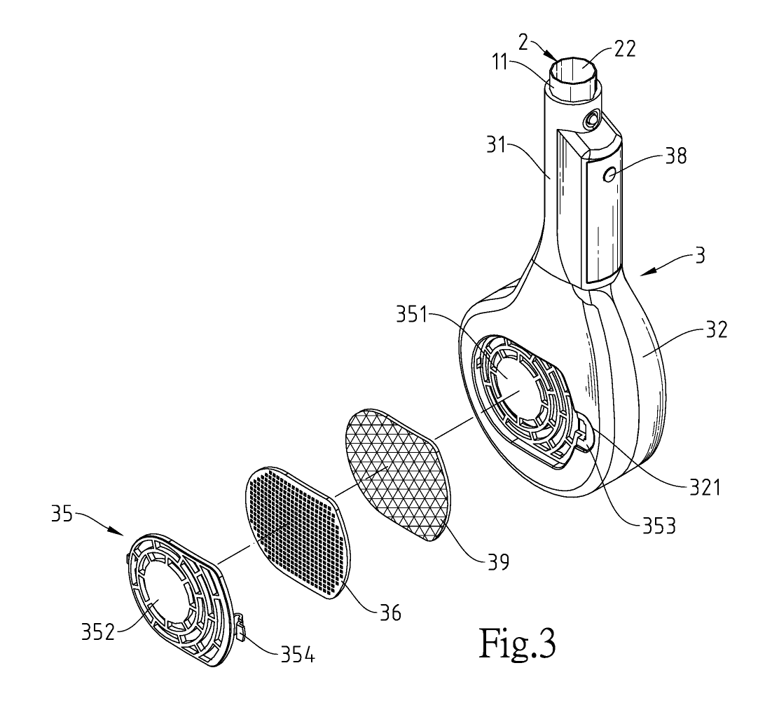

Referring to FIGS. 2-4, when the user switched on the on/off switch 38, the air drive unit 34 is activated to draw outside air into the diversion chamber 33. At this time, the intake flow of air is filtered by the air filter member 36 and flows through the air delivery channel 22 and the air outlet 23 into the air dispersing space 4 so that the user can breathe in clean air to prevent air pollution from harming the human body. Since the filtered air enters the dispersing space 4, a positive pressure state is formed in the dispersing space 4. Therefore, the outside air is prohibited from entering the dispersing space 4 from below to mix with the filtered air.

The air filter assembly 3 further comprises an aroma unit 39. The aroma unit 39 is a flake of fragrance mounted between the air filter member 36 and the first air grille 351. The air drawn into the diversion chamber 33 by the air drive unit 34 flows through the air filter member 36 and the aroma unit 39 to carry the pleasant smell of the aroma unit 39 through the air delivery channel 22 and the air outlet 23 into the air dispersing space 4.

Therefore, the present invention solves the conventional problems and defects, and the key technology lies in the arrangement of the air filter assembly 3 at the bottom end of the shaft 11 of the umbrella for drawing in outside air and filtering the intake flow of air for enabling the filtered air to be breathed by the umbrella user so that the umbrella user is prohibited from breathing in polluted air and can perform outdoor activities safely for a long time.

What the invention claimed is:

1. An air filter umbrella, comprising:
an umbrella body comprising a shaft having opposed top end and bottom end, a rib and stretcher assembly radially and pivotally connected to said top end of said shaft and a canopy covered on said rib and stretcher assembly such that an air dispersing space is defined within said canopy around said shaft;
an air delivery unit comprising an air inlet located on said bottom end of said shaft, an air outlet formed on said shaft near said top end of said shaft and an air delivery channel axially defined in said shaft between said air inlet and said air outlet; and
an air filter assembly fastened to said bottom end of said shaft of said umbrella body, said air filter assembly comprising an air drive unit adapted for drawing outside air through said air inlet, said air delivery channel and said air outlet into said air dispersion space, an air grille unit mounted in one side of said air filter unit to face toward said air drive unit and an air filter member mounted in said air grille unit, said air grille unit comprising a first air grille and a second air grille, said first air grille being disposed between said second air grille and said air drive unit, said air filter member being mounted between said first air grille and said second air grille.

2. The air filter umbrella as claimed in claim 1, wherein said air filter assembly further comprises an adapting grip fastened to said bottom end of said shaft and an air filter unit defining therein a diversion chamber, said diversion chamber being disposed in communication with said air inlet; said air drive unit and said air filter unit are mounted in said diversion chamber.

3. The air filter umbrella as claimed in claim 1, wherein said air filter assembly further comprises an aroma unit mounted between said air filter unit and said air drive unit so that the air drawn from the outside of the air filter umbrella into said air delivery unit flows said air filter unit and said aroma unit to carry an aromatic smell from said aroma unit into said air dispersing space.
